(19) United States
(12) Patent Application Publication
(10) Pub. No.: US 2008/0095063 A1
(43) Pub. Date: Apr. 24, 2008

(54) Relay Apparatus and Failure Monitoring Method

(75) Inventor: Tadashi Nakano, Fukuoka (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 11/857,538

(22) Filed: Sep. 19, 2007

(30) Foreign Application Priority Data
Oct. 20, 2006 (JP) 2006-286852

(51) Int. Cl. H04L 12/56

(52) U.S. Cl. 370/250

(57) ABSTRACT

In a failure monitoring unit, a packet sending unit sends a failure monitoring packet to a card to monitor whether a failure has occurred in a communication path to the card. A failure judging unit judges whether a failure has occurred in the communication path based on any one of presence or absence of a response and content of a response from the card in response to the failure monitoring packet. A send-timing controlling unit monitors traffic volume on the communication path, and controls a frequency of sending of the failure monitoring packet based on the current traffic volume.

### BACKGROUND OF THE INVENTION

1. Field of the Invention

The present invention relates to a relay apparatus and a failure monitoring method.

2. Description of the Related Art

In recent years, shelf-type relay apparatuses, such as layer 2 switches or layer 3 switches, are being used more frequently in networks such as the Internet. A typical shelf-type relay apparatus includes a cabinet called a shelf with a plurality of slots for installing various cards.

The cards that can be installed in the slots include, for example, interface cards connected to a communication cable, switch cards that relay data exchange between the cards. The shelf-type relay apparatus can realize flexible configuration that suites the requirement by changing the number and type of the cards, which are to be installed, according to the requirements of the shelf-type relay apparatus.

Networking within the shelf-type relay apparatus is possible for exchange of information such as data among the cards installed in the slots. Failure monitoring packets are periodically exchanged through the network to check whether operation of the cards is normal. Japanese Patent Application Laid-Open No. 2000-299696 discloses details regarding a technology in which failure monitoring packets are used to detect failures in a terminal connected to a network.

In a conventional shelf-type relay apparatus, a central processing unit (CPU) that is responsible for control of various communications of transferring main signals is also responsible for monitoring failures using failure monitoring packets. Therefore, a process of sending and receiving the failure monitoring packets is an extra load on the CPU, and this extra load creates delay in communication.

### SUMMARY OF THE INVENTION

It is an object of the present invention to at least partially solve the problems in the conventional technology.

According to an aspect of the present invention, there is provided a relay apparatus that relays information among a plurality of cards. The relay apparatus includes a switch that relays information among the cards; and a plurality of communication paths, each connecting the switch to a corresponding one of the cards, wherein the switch includes a packet generating unit that generates a failure monitoring packet to monitor whether a failure has occurred in any one of the communication paths; a packet sending unit that sends the failure monitoring packet to a first card from among the cards; a failure judging unit that judges whether a failure has occurred in a first communication path corresponding to the first card based on any one of presence or absence of a response and content of a response from the first card in response to the failure monitoring packet sent to the first card; and a controlling unit that monitors current traffic volume on the first communication path and controls a frequency of sending of the failure monitoring packet by the packet sending unit based on the current traffic volume.

According to another aspect of the present invention there provided a method of monitoring a failure in a relay apparatus that relays information among a plurality of cards, the relay apparatus including a switch that relays information among the cards; and a plurality of communication paths, each connecting the switch to a corresponding one of the cards. The method includes generating a failure monitoring packet to monitor whether a failure has occurred in any one of the communication paths; sending the failure monitoring packet to a first card from among the cards; judging whether a failure has occurred in a first communication path corresponding to the first card based on any one of presence or absence of a response and content of a response from the first card in response to the failure monitoring packet sent to the first card; and controlling that includes monitoring current traffic volume on the first communication path, and controlling a frequency of sending of the failure monitoring packet at the sending based on the current traffic volume.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a logical block diagram of a relay apparatus according to a first embodiment of the present invention;

FIG. 2 is a block diagram of a failure monitoring unit shown in FIG. 1;

FIG. 3 is an example of contents of a send timing table shown in FIG. 2;

FIG. 4 is a logical block diagram of a relay apparatus according to a second embodiment of the present invention;

FIG. 5 is a block diagram of a redundancy managing unit shown in FIG. 4;

FIG. 6 is a sequence chart of a redundancy switching operation;

FIG. 7 is an external view of a shelf-type relay apparatus;

FIG. 8 is a logical block diagram of a conventional relay apparatus; and

FIG. 9 is a logical block diagram of a conventional relay apparatus that has a redundancy configuration.

### DETAILED DESCRIPTION OF THE PREFERRED EMBODIMENTS

Exemplary embodiments of the present invention are explained in detail below with reference to the accompanying drawings.

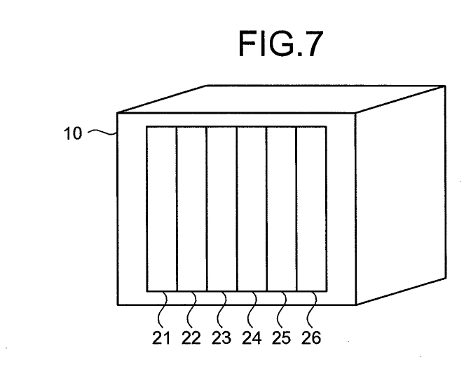

FIG. 7 is an external view of a shelf-type relay apparatus. The shelf-type relay apparatus includes a shelf 10 and cards 21 to 26. The shelf 10 is housing with a plurality of slots for installing the cards 21 to 26. The shelf 10 is an electronic circuit board with a predetermined function.

The slots are arranged on a back wired board (BWB). The slots are electrically connected through a switch or a bus. The shelf 10 can have any number of slots, including those in other examples explained below, and it is not necessary to install a card in each of the slots.

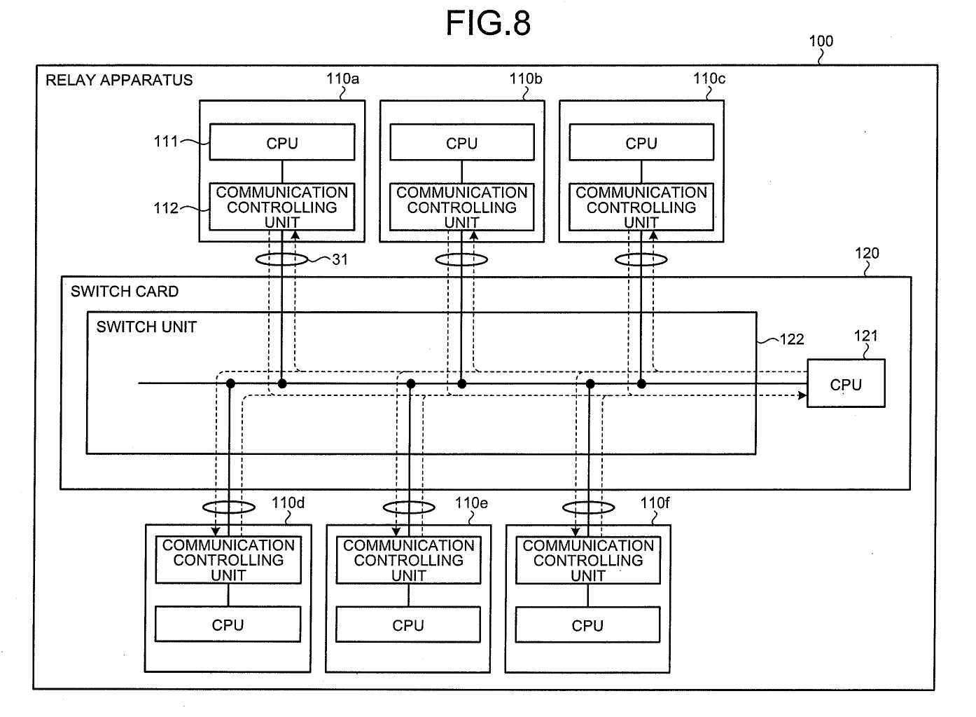

FIG. 8 is a logical block diagram of a conventional relay apparatus 100. The conventional relay apparatus 100 is a shelf-type relay apparatus, and includes cards 110a to 110f and a switch card 120.

Each of the cards 110a to 110f is an electronic circuit board with a predetermined function, for example, an interface card for connecting the conventional relay apparatus 100 to a communication cable. Each of the cards 110a to 110f includes a central processing unit (CPU) 111, and a communication controlling unit 112. The CPU 111 is responsible for various operations, and the communication controlling unit 112 is responsible for interaction within the conventional relay apparatus 100 such as data exchange.

The switch card 120 functions as a switch for exchange of, for example, data among the cards 110a to 110f, and includes a CPU 121 and a switch unit 122. The CPU 121 is responsible for various operations, and the switch unit 122 relays data that is exchanged among the cards 110a to 110f.

The cards 110a to 110f and the switch card 120 are electrically connected through a BWB wiring 31. Exchange among the cards 110a to 110f can be controlled based on a general protocol such as the transmission control protocol/Internet protocol (TCP/IP) or a dedicated protocol.

The various operations controlled by the CPU 121 include checking whether operation of the cards is normal. Specifically, the CPU 121 periodically generates a failure monitoring packet and sends the failure monitoring packet in sequence to each of the cards 110a to 110f to check whether operation of the cards is normal.

The failure monitoring packet sent by the CPU 121 is transferred to a destination card by the switch unit 122, and the CPU 111 of the destination card sends a failure-monitoring response packet indicative of normality to the CPU 121 in response to the failure monitoring packet. If a failure occurs in the destination card or in a path to the destination card, either a failure-monitoring response packet is not sent to the CPU 121 or a failure-monitoring response packet indicative of the failure is sent to the CPU 121.

When the CPU 121 detects a failure in any one of the paths to the cards 110a to 110f or a path in the switch card 120 based on the failure-monitoring response packet, the CPU 121 performs necessary processes such as a process of notifying a network managing terminal of the failure, or a process of redundancy switching. The redundancy switching refers to switching the switch card between active and standby.

In the conventional relay apparatus 100, the CPU 121 executes the failure monitoring control along with various other controls. The failure monitoring control needs to be executed periodically. This imposes an extra load on the CPU 121, which results in delaying other important controls. Particularly, when the number of cards installed in the relay apparatus increases, the load on the CPU 121 also increases.

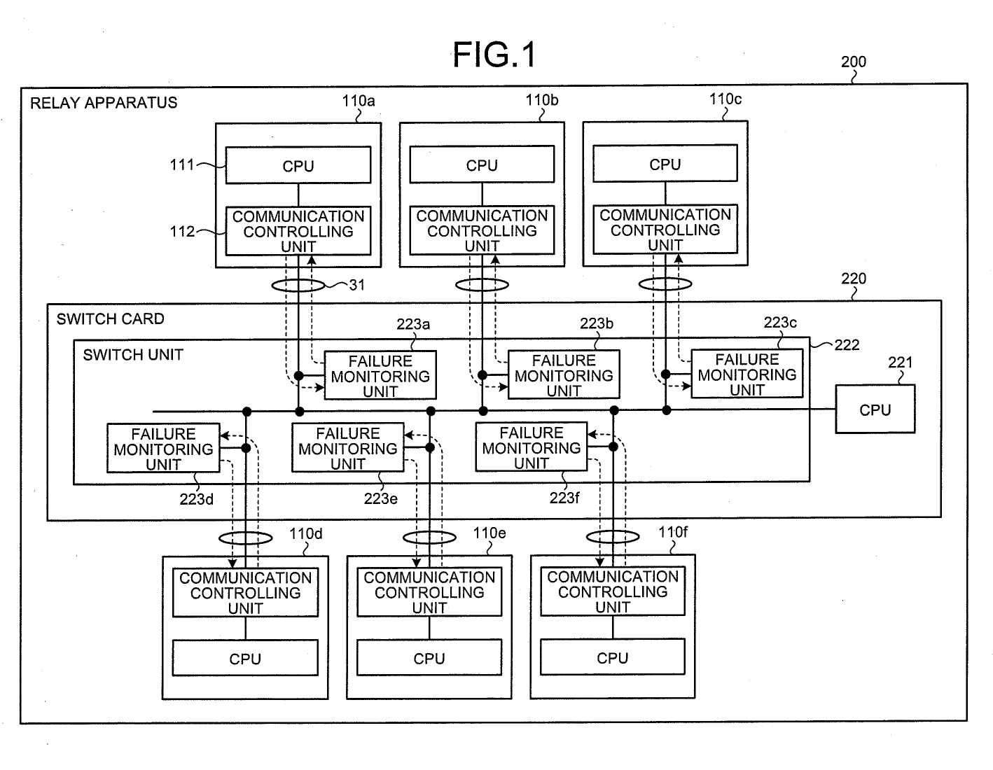

Explained below is a relay apparatus according to an embodiment of the present invention. Parts corresponding to those in the above example are denoted with the same reference numerals, and the same description is not repeated. FIG. 1 is a logical block diagram of a relay apparatus 200 according to a first embodiment of the present invention. The relay apparatus 200 is a shelf-type relay apparatus and includes the cards 110a to 110f and a switch card 220.

The switch card 220 functions as a switch for exchange of, for example, data among the cards 110a to 110f, and includes a CPU 221 and a switch unit 222. The CPU 221 is responsible for various operations, and the switch unit 222 relays data that is exchanged among the cards 110a to 110f.

The switch unit 222 includes failure monitoring units 223a to 223f. The failure monitoring units 223a to 223f are located on interaction lines each of which connects the switch apparatus 200 to corresponding one of the cards 110a to 110f, respectively. In FIG. 1, the failure monitoring units 223a to 223f are located at each of the interaction lines connecting to the cards 110a to 110f to the CPU 221.

The failure monitoring units 223a to 223f execute the failure monitoring control in place of the CPU 221, and send failure monitoring packets to the cards that are connected to respective interaction lines. The failure monitoring units 223a to 223f judge the state of the cards and the path to the cards, based on the response to the failure monitoring packets. Thus, the CPU 221 need not execute failure monitoring control, and can focus on its primary operations such as communication control.

The failure monitoring units 223a to 223f monitor traffic at the respective interaction lines. If the traffic increases at the respective interaction lines, the failure monitoring units 223a to 223f reduce the frequency of sending the failure monitoring packets accordingly. Thus, when traffic between a particular card and the switch unit 222 increases, and the load on the CPU 111 increases, it is possible to prevent delay in processing that is likely to occur due to handling of the failure monitoring packets by the CPU 111.

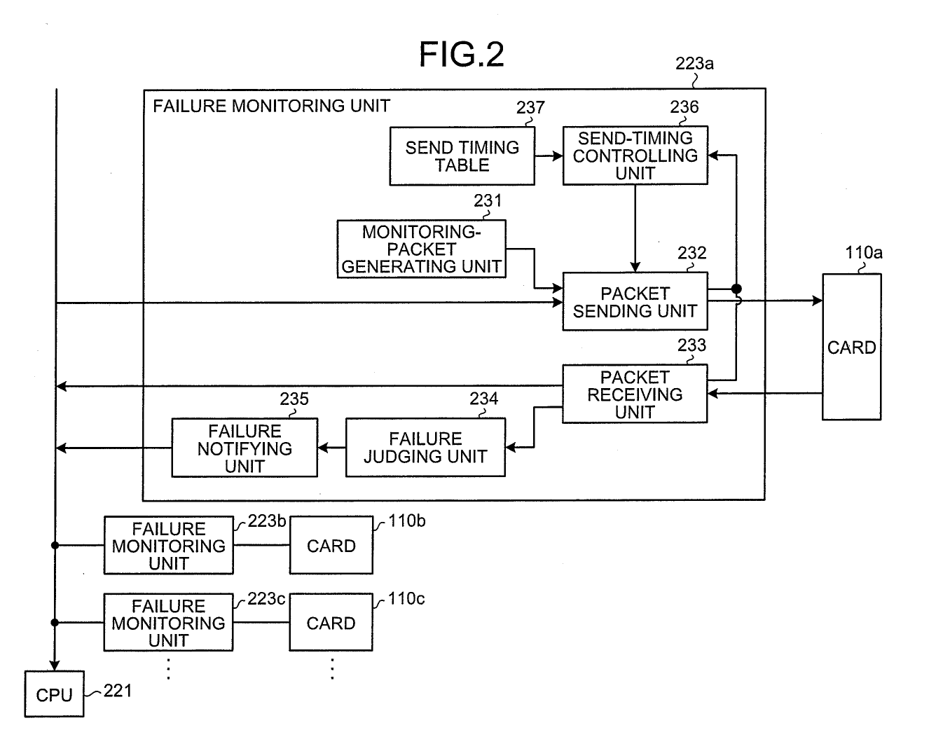

Because each of the failure monitoring units 223a to 223f is same in configuration, configuration of the failure monitoring unit 223a alone is explained as an example. FIG. 2 is a block diagram of the failure monitoring unit 223a.

The failure monitoring unit 223a includes a monitoring-packet generating unit 231, a packet sending unit 232, a packet receiving unit 233, a failure judging unit 234, a failure notifying unit 235, a send-timing controlling unit 236, and a send timing table 237. The monitoring-packet generating unit 231 generates a failure monitoring packet for checking the state of the card 110a.

The packet sending unit 232 multiplexes the failure monitoring packet generated by the monitoring-packet generating unit 231 with an ordinary packet addressed to the card 110a, and sends the multiplexed packet to the card 110a. The packet sending unit 232 measures the volume of traffic towards the card 110a, based on the number of ordinary packets addressed to the card 110a, and notifies the result to the send-timing controlling unit 236.

The packet receiving unit 233 receives a packet from the card 110a, and separates the received packet into a failure-monitoring response packet that is a response to the failure monitoring packet and an ordinary packet. The packet receiving unit 233 transfers the failure-monitoring response packet to the failure judging unit 234, and transfers the ordinary packet to a destination card. The packet receiving unit 233 measures the volume of traffic from the card 110a, based on the number of ordinary packets received from the card 110a, and notifies the result to the send-timing controlling unit 236.

The failure judging unit 234 receives the failure-monitoring response packet separated by the packet receiving unit 233, and monitors a state of the communication path towards the card 110a. If a time period within which a packet can be received expires or if the failure-monitoring response packets include information that indicates a failure, the failure judging unit 234 judges that a failure has occurred in the communication path towards the card 110a and notifies the failure notifying unit 235 of the failure.

Having notified of the failure by the failure judging unit 234, the failure notifying unit 235 sends a failure notification to the CPU 221. When the CPU 221 receives the failure notification, the CPU 221 performs processes such as notifying a network managing terminal of the failure or exploring an alternative path.

The send-timing controlling unit 236 decides timing for the packet sending unit 232 to send the failure-monitoring response packet to the card 110a, based on the traffic volume notified by the packet sending unit 232 and the packet receiving unit 233, and notifies the packet sending unit 232 of the timing. The send-timing controlling unit 236 refers to the send timing table 237 to decide timing for sending the failure-monitoring response packet.

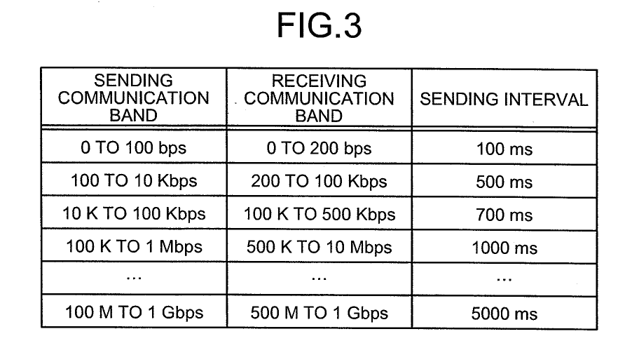

An example of contents of the send timing table 237 is shown in FIG. 3. The send timing table 237 includes a sending communication band, a receiving communication band, and a sending interval. The sending communication band indicates the volume of traffic from the switch unit 222 towards the card 110a, and can have ranges such as 0 bps (bit per second) to 100 bps. The receiving communication band indicates volume of traffic from the card 110a towards the switch unit 222, and can have ranges such as 0 bps to 200 bps.

The sending interval indicates an interval with which failure monitoring packets are sent. The sending interval is decided based on volume of the traffic with respect to the sending communication band and the receiving communication band. The sending interval can have values such as 100 milliseconds. As shown in the send timing table 237, the larger the traffic volume becomes, the longer the sending interval becomes. Accordingly, it is possible to prevent delay occurring due to increased load on the CPU 111.

Based on prerecorded settings by a network manager, the send-timing controlling unit 236 periodically refers to the send timing table 237 to acquire a proper sending interval based on the current traffic volumes for the sending communication band and the receiving communication band, either one of which is prioritized than the other. The send-timing controlling unit 236 notifies the proper sending interval of the packet sending unit 232 to cause the packet sending unit 232 to send the failure monitoring packets spaced with the proper sending interval.

As mentioned above, in the first embodiment, the cards 110a to 110f are allotted with the failure monitoring units 223a to 223f, respectively at the respective interaction lines. Each of the failure monitoring units 223a to 223f monitors the corresponding card for any failure, in place of the CPU 221. Thus, load on the CPU 221, which controls various operations, is reduced, and it is possible to prevent delay due to the CPU 221.

In such a configuration, because it is possible for the failure monitoring units 223a to 223f to send the failure monitoring packets in parallel, instead of the single CPU sending the failure monitoring packets to each of the cards sequentially, it is possible to discover failure at an early stage. Furthermore, even if the number of cards installed in the relay apparatus increases, load for the failure monitoring are distributed, and load on each of the failure monitoring units does not increase.

In the first embodiment, the larger the traffic volume is, the lower the frequency of sending the failure monitoring packets is set. Thus, it is possible to prevent traffic congestion and processing delay responsible for the failure monitoring packets.

In the first embodiment, the relay apparatus is provided with one switch card. However, when there is a demand for higher reliability, two switch cards are provided in the relay apparatus, one as an active switch card and the other as a standby switch card, creating a redundancy configuration.

In the conventional relay apparatus having such a redundancy configuration, if a failure occurs in a path between the active switch card and another card, a process of switching a system from the active switch card to the standby switch card is performed by the CPU as one of the various operations.

To switch the active switch card to the standby switch card, a switching instruction is sent to each of the cards installed in the relay apparatus. The CPU can not execute any other controls while issuing the switching instruction, so that the communication is disrupted for a long time. To solve the problem, a relay apparatus according to a second embodiment of the present invention is provided.

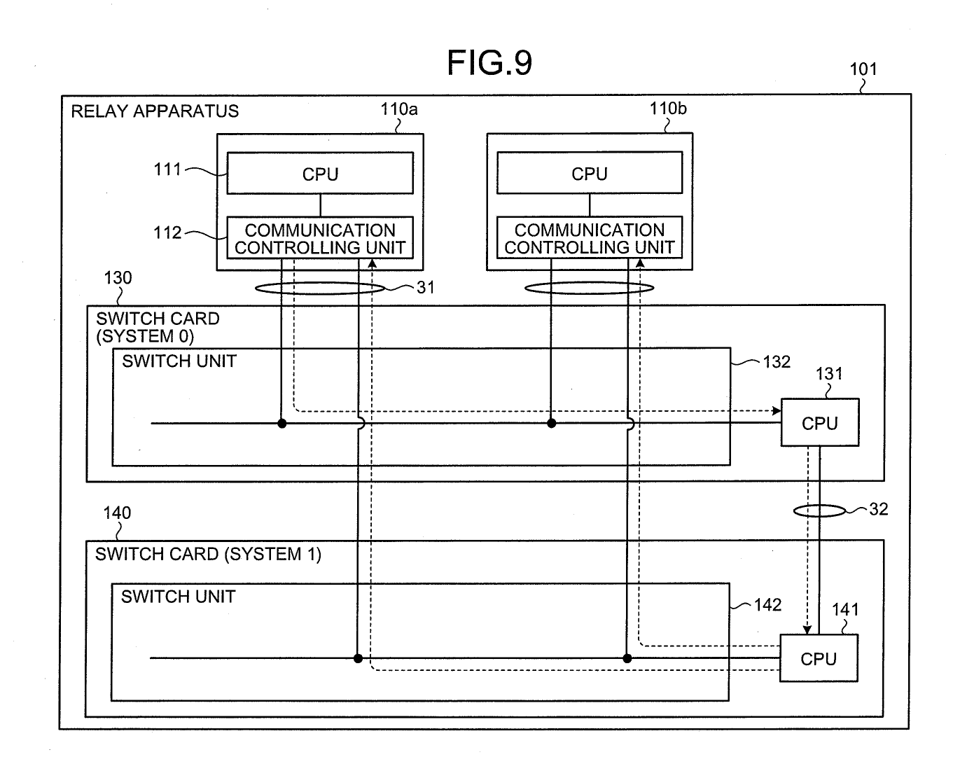

FIG. 9 is a logical block diagram of a conventional relay apparatus 101 having the redundancy configuration. The relay apparatus 101 is a shelf-type relay apparatus, and includes the cards 110a and 110b, and switch cards 130 and 140.

The switch card 130 (System 0) functions as a switch for exchange of, for example, data between the cards 110a and 110b, and includes a CPU 131 and a switch unit 132 that relays data between the cards. The switch card 140 (System 1) is same in configuration as the switch card 130, and includes a CPU 141 and a switch unit 142.

The cards 110a and 110b are connected to each other through two paths; one is a path of System 0 passing through the switch card 130 and another is a path of System 1 passing through the switch card 140. Either the path of System 0 or the path of System 1 is for an active switch card and the other path is for a standby switch card.

Redundancy switching operation in the relay apparatus 101 is explained assuming that System 0 is for an active switch card. The CPU 131 that controls data exchange through the path of System 0 monitors whether a failure has occurred in the communication path by periodically sending failure monitoring packets to the cards 110a and 110b.

Upon detecting that the quality of a communication path of the System 0 is deteriorated from, for example, a failure monitoring response packet received from the card 110a that indicates occurrence of a failure in the communication path, the CPU 131 sends, through a communication path 32 between Systems 0 and 1, a request for the CPU 141 to perform redundancy switching.

Upon receiving the request, the CPU 141 sends a packet for instructing switching of system to the cards 110a and 110b through a path of its own system. Upon receiving the packet, the cards 110a and 110b exchange data through the path of System 1. Thus, the operation of redundancy switching is complete.

The conventional relay apparatus can revive the communication automatically by switching to the path of another system. However, during the switching process, the CPU 131 and the CPU 141 cannot perform usual communication processes, which results in disruption in communication.

When the number of cards installed in the relay apparatus, to which the packets instructing switching are sent, increases, the disruption in communication due to the redundancy switching also becomes longer, as in the case of a plurality of switch cards that are connected in cascading manner to form Systems 0 and 1 structure.

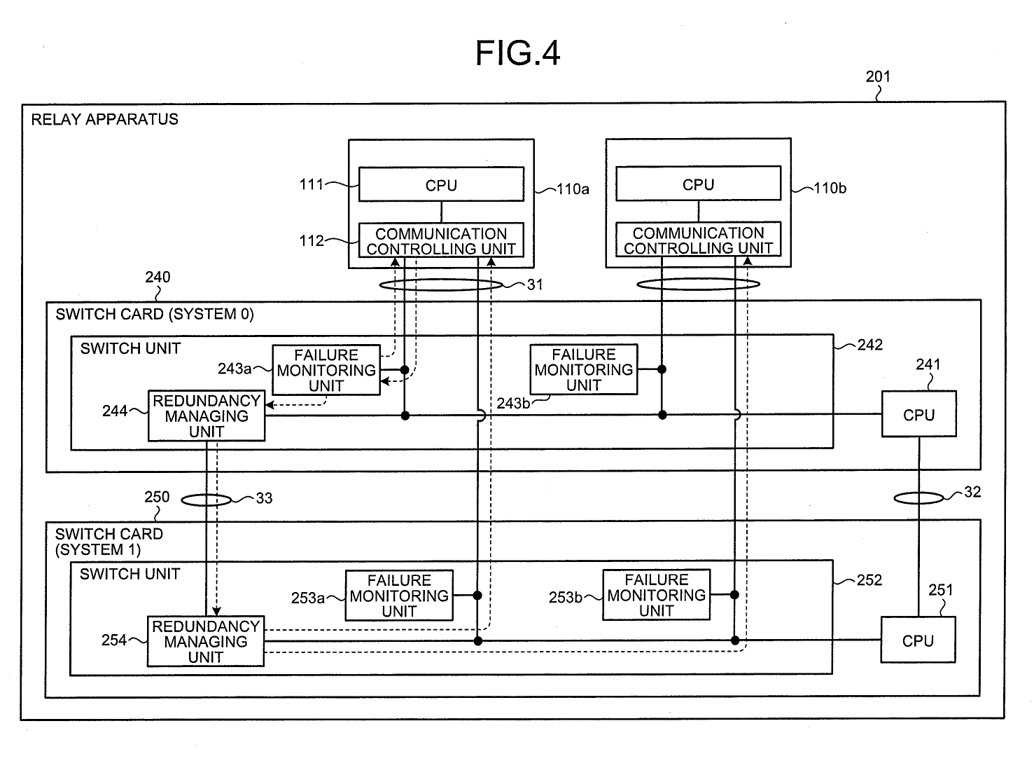

FIG. 4 is a logical block diagram of a relay apparatus 201 according to the second embodiment. The relay apparatus 201 is a shelf-type relay apparatus and includes the cards 110a and 110b and switch cards 240 and 250.

The switch card 240 (System 0) functions as a switch for exchange of, for example, data among the cards 110a and 110b, and includes a CPU 241 and a switch unit 242.

The switch unit 242 includes failure monitoring units 243a and 243b that are located at respective interaction lines connecting the cards 110a and 110b. The switch unit 242 includes a redundancy managing unit 244.

The failure monitoring units 243a and 243b execute failure monitoring control in place of the CPU 241, and send failure monitoring packets to the cards 110a and 110b that are connected through the respective interaction lines. The failure monitoring units 243a and 243b judge the state of the cards and the path to the cards, based on the response to the failure monitoring packets. The redundancy managing unit 244 controls redundancy switching.

The switch card 250 is (System 1) same in configuration as the switch card 240, and includes a CPU 251 and a switch unit 252. The switch unit 252 includes failure monitoring units 253a and 253b that execute failure monitoring control, and a redundancy managing unit 254.

The cards 110a and 110b are connected by two paths one is a path of System 0 through the switch card 240 and another is a path of System 1 through the switch card 250. Either Systems 0 path or System 1 path is for an active switch card, and the other is for a standby switch card in a redundancy configuration.

The failure monitoring units 243a and 243b have the same configuration as the failure monitoring unit 223a. If a failure is detected in a communication path to any one of the cards 110a and 110b, the failure notifying unit 235 sends a failure notification to both of the CPU 241 and the redundancy managing unit 244.

Upon receiving the failure notification, the redundancy managing unit 244 sends a redundancy switching request to the redundancy managing unit 254 of the other system through a communication path 33 that connects the redundancy managing units 244 and 254. Upon receiving the redundancy switching request, the redundancy managing unit 254 sends a packet through the failure monitoring units 253a and 253b to instruct the cards 110a and 110b to switch systems.

The failure monitoring units 253a and 253b have the same configuration as the failure monitoring unit 223a. If a failure is detected in a communication path to any one of the cards, the failure notifying unit 235 sends a failure notification to both the CPU 251 and the redundancy managing unit 254.

Upon receiving the failure notification, the redundancy managing unit 254 sends a redundancy switching request to the redundancy managing unit 244 of the other system through the communication path 33. Upon receiving the redundancy switching request, the redundancy managing unit 244 sends a packet through the failure monitoring units 243a and 243b to instruct the cards 110a or 110b to switch systems. Thus, the process of redundancy switching is complete.

Thus, in the relay apparatus 201, the redundancy managing units 244 and 254 perform the process of redundancy switching in place of the CPU 241 and the CPU 251. Therefore, the CPU 241 and the CPU 251 can focus on performing ordinary process of communication, and it is possible to minimize disruption in communication.

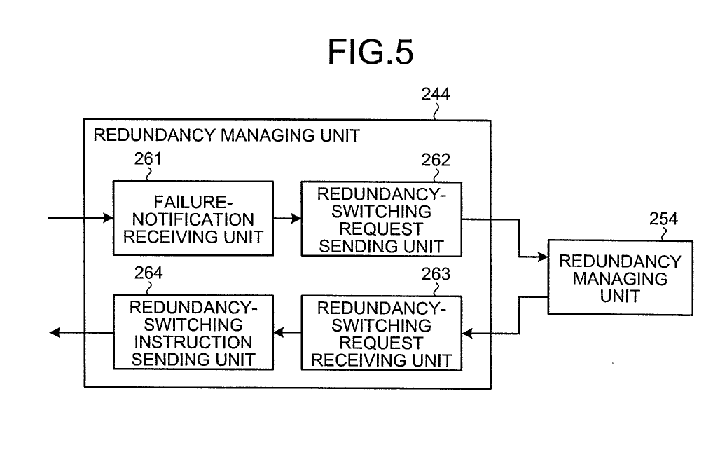

Explained below is configuration of the redundancy managing units 244 and 254. The redundancy managing units 244 and 254 have same configuration. Therefore, configuration of the redundancy managing unit 244 alone is explained below. FIG. 5 is a block diagram of the redundancy managing unit 244.

The redundancy managing unit 244 includes a failure-notification receiving unit 261, a redundancy-switching request sending unit 262, a redundancy-switching request receiving unit 263, and a redundancy-switching instruction sending unit 264. The failure-notification receiving unit 261 receives a failure notification from a failure monitoring unit, and notifies the redundancy-switching request sending unit 262. When the redundancy-switching request sending unit 262 is notified by the failure-notification receiving unit 261, the redundancy-switching request sending unit 262 sends a request to redundancy managing unit of another system that redundancy switching is necessary.

Upon receiving the redundancy switching request from redundancy managing unit of the other system, the redundancy-switching request receiving unit 263 notifies the redundancy-switching instruction sending unit 264. The redundancy-switching instruction sending unit 264 sends a redundancy switching instruction to each of the cards through a failure monitoring unit.

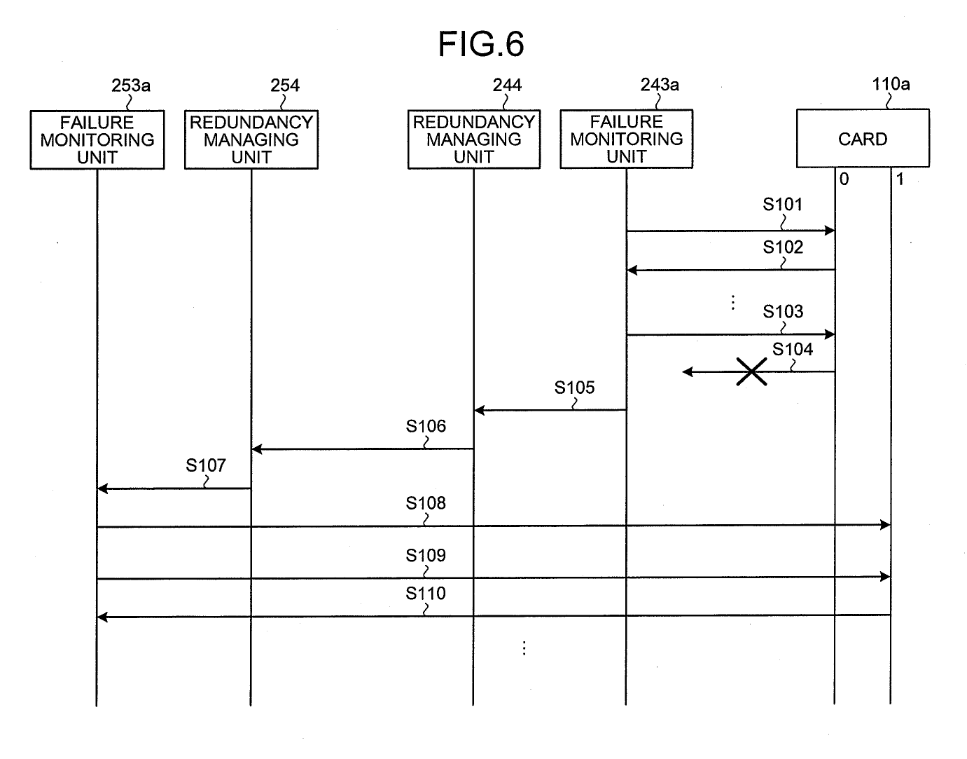

Explained below is an example regarding an operation of the relay apparatus 201 when System 0 is an active system, and a failure occurs in a path connecting the card 110a and the switch card 240. FIG. 6 is a sequence chart of redundancy switching operation.

The failure monitoring unit 243a sends failure monitoring packets to the card 110a at a predetermined interval (step S101). The card 110a replies failure monitoring response packets in response to the failure monitoring packets (step S102).

After repeating several sets of steps S101 and S102, when the failure monitoring unit 243a sends a failure monitoring packet (step S103), a failure monitoring response packet is not replied (step S104), the failure monitoring unit 243a judges that a failure has occurred in the path to the card 110a, and sends a notification to the redundancy managing unit 244 (step S105).

Upon receiving the notification, the redundancy managing unit 244 sends a redundancy switching request to the redundancy managing unit 254 for making System 1 as the current system (step S106). Upon receiving the redundancy switching request the redundancy managing unit 254 sends a redundancy switching instruction to the failure monitoring unit 253a (step S107). The failure monitoring unit 253a transfers the redundancy switching instruction to the card 110a (step S108). Thereafter, the redundancy managing unit 254 sends a redundancy switching instruction to the card 110b through the failure monitoring unit 253b.

Upon receiving the redundancy switching instruction, the cards 110a and 110b exchange data through the switch card 250. The failure monitoring unit 253a sends the failure monitoring packet to the card 110a at the predetermined interval (step S109), the card 110a responds to this by sending a failure monitoring response packet (step S110). The process is repeated in similar manner.

In the second embodiment, the redundancy managing units 244 and 254 are configured to execute control of the redundancy switching in place of the CPUs 241 and 251. Therefore, the CPUs 241 and 251 can execute their ordinary communication controls and minimize communication disruption due to redundancy switching.

The relay apparatuses 200 and 201 can be modified without departing from the scope of the invention. For example, it is possible to arrange one failure monitoring unit in a switch card instead of arranging the failure monitoring unit on each of interaction paths to the cards, and the single failure monitoring unit monitors all the paths to the cards. Furthermore, it is possible to arrange a switch in a BWB of a main body of the shelf in place of a switch that is realized as a card to relay exchange between the cards.

According to an embodiment of the present invention, it is possible to reduce the load of failure monitoring on a CPU. As a result, the relay apparatus can avoid delay likely to occur when load of communication control, which is an ordinary function of the CPU, increases.

Moreover, it is possible to detect a failure at an early stage by executing a process of failure monitoring in parallel.

Furthermore, it is possible to easily adjust sending intervals of failure monitoring packets according to the capability of a model in use.

Moreover, it is possible to minimize disruption of communication due to redundancy switching.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A relay apparatus that relays information among a plurality of cards, the relay apparatus comprising:
a switch that relays information among the cards; and
a plurality of communication paths, each connecting the switch to a corresponding one of the cards, wherein
the switch includes
a packet generating unit that generates a failure monitoring packet to monitor whether a failure has occurred in any one of the communication paths;
a packet sending unit that sends the failure monitoring packet to a first card from among the cards;
a failure judging unit that judges whether a failure has occurred in a first communication path corresponding to the first card based on any one of presence or absence of a response and content of a response from the first card in response to the failure monitoring packet sent to the first card; and
a controlling unit that monitors current traffic volume on the first communication path and controls a frequency of sending of the failure monitoring packet by the packet sending unit based on the current traffic volume.

2. The relay apparatus according to claim 1, wherein the controlling unit decreases the frequency of sending of the failure monitoring packet when the current traffic volume is higher than a threshold.

3. The relay apparatus according to claim 1, wherein the packet generating unit, the packet sending unit, the failure judging unit, and the controlling unit are provided on each of the communication paths.

4. The relay apparatus according to claim 1, the switch further comprising a storing unit that stores therein a table of correspondence of frequencies and traffic volumes, wherein
the controlling unit decides the frequency based on the table.

5. The relay apparatus according to claim 1, wherein the switch includes at least a first switch and a second switch, the first communication path includes a second communication path between the first card and the first switch and a third communication path between the first card and the second switch, each of the first and the second switches further including
a request sending unit; and
an instructing unit, wherein
when the failure judging unit of the first switch judges that a failure has occurred in the second communication path, the request sending unit of the first switch sends a redundancy switching request to the second switch, and
upon receiving the redundancy switching request from the first switch, the instructing unit of the second switch sends to the first card through the third communication path an instruction that causes information exchanged among the cards to be passed through the second switch.

6. A method of monitoring a failure in a relay apparatus that relays information among a plurality of cards, the relay apparatus including a switch that relays information among the cards; and a plurality of communication paths, each connecting the switch to a corresponding one of the cards, the method comprising:
generating a failure monitoring packet to monitor whether a failure has occurred in any one of the communication paths;
sending the failure monitoring packet to a first card from among the cards;
judging whether a failure has occurred in a first communication path corresponding to the first card based on any one of presence or absence of a response and content of a response from the first card in response to the failure monitoring packet sent to the first card;
monitoring current traffic volume on the first communication path; and
controlling a frequency of sending of the failure monitoring packet at the sending based on the current traffic volume.

7. The method according to claim 6, wherein the controlling includes decreases the frequency of sending of the failure monitoring packet when the current traffic volume is higher than a threshold.

8. The method according to claim 6, wherein a series of the generating, the sending, the judging, and the controlling is performed with regard to each of the communication paths.

9. The method according to claim 6, wherein
the switch further including a storing unit that stores therein a table of correspondence of frequencies and traffic volumes, and
the controlling includes deciding the frequency based on the table.

10. The method according to claim 6, wherein the switch includes at least a first switch and a second switch, the first communication path includes a second communication path between the first card and the first switch and a third communication path between the first card and the second switch, the method further comprising:
when it is judged that a failure has occurred in the second communication path at the judging performed by the first switch, sending a redundancy switching request from the first switch to the second switch; and
upon receiving the redundancy switching request from the first switch, sending from the second switch to the first card through the third communication path an instruction that causes information exchanged among the cards to be passed through the second switch.
